(19) United States
(12) Patent Application Publication
(10) Pub. No.: US 2026/0212659 A1
(43) Pub. Date: Jul. 23, 2026

(54) METHOD AND SYSTEM OF IMAGE CLASSIFICATION USING A DEEP NEURAL NETWORK EMBEDDED WITH MULTI-SCALE SPATIAL ATTENTION MECHANISM

(71) Applicant: Ashish GHOSH, Kolkata (IN)

(72) Inventors: Ashish GHOSH, Kolkata (IN); Susmita GHOSH, Kolkata (IN); Abhiroop CHATTERJEE, Kolkata (IN)

(21) Appl. No.: 19/026,839

(22) Filed: Jan. 17, 2025

(51) Int. Cl. G06V 10/82; G06N 3/048; G06N 3/08; G06V 10/776

(52) U.S. Cl. CPC G06V 10/82; G06N 3/048; G06N 3/08; G06V 10/776

(57) ABSTRACT

The present invention provides a method for image classification by incorporating a deep neural network embedded with multiscale spatial attention mechanism (MSSAM). The method according to the present invention comprises various stages: Stage I—Data preparation stage; Stage II—Model training stage; Stage III—Evaluation and Testing stage; Stage IV—Iterative optimization stage. During Data preparation stage, data is collected from a large and diverse dataset of images relevant to specific classification task. During the Model training stage, the model architecture is established, appropriate loss function is selected, an optimizer and an initial learning rate is chosen, the model is trained on training dataset, monitoring validation performance and experiments are performed with hyperparameters. During the Evaluation and Testing stage, model's performance is evaluated on the validation set using metrics and during Iterative optimization stage, the optimization process is iterated and continuously monitored for best results.

### FIELD OF THE INVENTION

The present invention relates to the field of image classification using a neural network architecture. Particularly, the present invention relates to deep neural network architecture embedded with a multi-scale spatial attention mechanism (MSSAM). More particularly, the present invention comprises a methodology which provides image classification by incorporating multi scale spatial attention mechanism, (MSSAM) that enhances the model's ability to focus on important image regions.

### BACKGROUND OF THE INVENTION

A neural network is a subset of machine learning, also known as deep learning, that uses interconnected nodes or neurons in a layered structure that resembles a human brain.

Convolutional neural networks, also called ConvNets or CNNs, have several layers in which data is sorted into categories. These networks have an input layer, an output layer, and a multitude of convolutional layers in between. The layers create feature maps that record areas of an image that are broken down further until they generate valuable outputs. These layers can be pooled or entirely connected, and these networks are especially beneficial for image recognition applications. Neural networks can work continuously and are more efficient than humans or simpler analytical models. Neural networks can also be programmed to learn from prior outputs to determine future outcomes based on the similarity to prior inputs. Though the complexity of neural networks is a strength, this may mean it takes months (if not longer) to develop a specific algorithm for a specific task. In addition, it may be difficult to spot any errors or deficiencies in the process, especially if the results are estimates or theoretical ranges.

The field of deep learning has witnessed significant advancements in image classification methodologies. Convolutional neural networks (CNNs) have become the backbone of many image classification solutions. They are designed to automatically learn hierarchical features from images, starting from simple features like edges and textures to more complex ones like object parts and whole objects. CNNs consist of multiple convolutional layers followed by pooling layers and fully connected layers. Various CNN models are available in the market (example: VGG-16, AlexNet, VGG-19 and DenseNet-201) to obtain useful deep features for performing many tasks of classification and recognition. Efforts are also made to improve the image classification methodology (example: A growing concern in deep learning is the need for models to be interpretable and explainable). Researchers have been developing methods to generate heatmaps or attention maps to visualize which parts of an image contribute most to classification decisions, aiding in model transparency and trust.

Reference is made to the patent publication number US20230004749A1 that discloses a system, a method, and a non-transitory computer readable storage medium for base calling. The base calling method includes processing through a neural network where firstly image data comprising images of clusters and their surrounding background are captured by a sequencing system for one or more sequencing cycles of a sequencing run. However, for complex images, selecting features from the set of images manually for feeding into neural network is a challenging task.

Reference is made to patent number JP6997309B2, that discloses a computer device including a storage unit and a processing unit coupled to the storage unit to process images. More particularly, the prior art relates to image processing for defining a new image from a source image, and more particularly to image processing using a deep neural network such as a convolutional neural network. However, Conventional convolutional neural network (CNN) based image processing system does not have the option of prioritizing significant regions.

None of the prior art techniques demonstrates excellent performance across various metrics: high recall, precision, and F1-score.

Furthermore, the challenges faced by the prior technology generally comprises:
i. Computational Complexity: Many sophisticated neural network architectures, especially those with attention mechanisms and multiple branches, can be computationally intensive. This complexity may result in longer training times and higher resource requirements.
ii. Overfitting: Complex models with large number of parameters are susceptible to overfitting. Regularization techniques like dropout are commonly employed to mitigate this, but it may still be a concern.
iii. Interpretability: As neural networks become more complex, interpreting, and understanding the decisions made by the model can be challenging. This lack of interpretability may be a limitation, especially in applications where transparency is crucial.
iv. Data Dependency: Neural networks heavily rely on the quality and quantity of the training data. In scenarios where obtaining labelled data is difficult or expensive, the performance of the model may be compromised.
v. Generalization to New Domains: Neural networks trained on specific datasets may struggle to generalize well to new, unseen data or different domains. This limitation is particularly relevant when deploying models in real-world settings.
vi. Hyperparameter Sensitivity: The performance of neural networks is influenced by various hyperparameters, and finding the optimal set can be challenging. Small changes in hyperparameters may lead to significantly different model performance.
vii. Large Storage and Memory Requirements: Deep neural networks, especially those with a large number of layers and parameters, may require significant storage space and memory, limiting their deployment on resource-constrained devices. Also, the generation of interpretable attention maps and their incorporation into the model's decision-making process is challenging, as it involves developing methods to make deep learning models more transparent and understandable. Custom attention mechanism can provide more interpretable results, allowing it to understand which regions the model considers important.

Thus, a need arises to provide convolutional neural networks (CNNs) for various classification systems that requires less computational resources for training, mitigates the risk of overfitting, better attention mechanism, and shows excellent performance across various metrics such as high recall, precision, and F1-score.

### OBJECTIVE OF THE INVENTION

The primary objective of the present invention is to provide a methodology which focuses on improved image classification.

Another objective of the present invention is to provide a deep neural network architecture optimized for image classification tasks.

Yet another objective of the present invention is early detection, recognition, and classification of various diseases, including but not limited to, Covid-19 from radiographic images.

Yet another objective of the present invention is to train and validate loss values with respect to the number of training epochs.

Yet another objective of the present invention is to provide accuracy of more than 97% in extracting capabilities by focusing on significant regions within input image by incorporating the deep neural network architecture of the present invention.

Yet another objective of the present invention is to provide correct prediction of positive cases and high level of accuracy in classification tasks.

### SUMMARY OF THE INVENTION

Accordingly, the present invention provides a method for image classification by incorporating a deep neural network embedded with multiscale spatial attention mechanism (MSSAM). The method according to the present invention comprises a data preparation stage comprising processing a plurality of the dataset of images by resizing the images to the desired dimensions and augmenting the resized images; at least one model training stage comprising establishing the model architecture, selecting loss function for the classification task, choosing optimizer and an initial learning rate, training the model on the training dataset, optimizing the model performance; an evaluation and Testing stage comprising evaluating the model performance; and an iterative optimization stage. The present invention also provides a model architecture comprising a deep neural network architecture optimized for image classification tasks and it is designed to effectively extract features from input images and make accurate predictions.

### BRIEF DESCRIPTION OF DRAWINGS

The present invention will be better understood after reading the following detailed description of the presently preferred aspects with reference to the appended drawings:

FIG. 1 illustrates the schematic representation of a neural network architecture.

FIG. 2 illustrates Multi-Scale Spatial Attention Mechanism (MSSAM).

FIG. 3 illustrates the architecture of the deep neural network specifically aimed for image classification tasks.

FIG. 4A and FIG. 4B illustrate images acquired from SARS-COV-2 CT scan dataset, that is, (FIG. 4A) Covid-19 and FIG. 4B) Non Covid-19 which are used as input data for the image classification task.

FIG. 5A and FIG. 5B illustrate visual comparison between original input image (FIG. 5A) and intermediate feature representation obtained after passing the input image through the proposed Multi-Scale Spatial Attention Mechanism (MSSAM) module in the neural network (FIG. 5B), according to the present invention.

FIG. 6 illustrates variation in training and validation accuracies with epochs for neural network and MSSAM.

FIG. 7 illustrates variation in training and validation loss values with respect to the number of training epochs for deep neural network architecture embedded with a multi-scale special attention mechanism (MSSAM).

FIG. 8 illustrates Intersection over Union (IoU) curves, which is a critical metric in image segmentation and object detection for Covid-19 and Non Covid-19 classes.

FIG. 9 illustrates confusion matrix for Covid-19 detection for the deep neural network architecture embedded with a multi-scale special attention mechanism (MSSAM).

Other objects and advantages of the present invention will become apparent from the following description taken in connection with the accompanying drawings, wherein, by way of illustration and example, the aspects of the present invention are disclosed.

### DETAILED DESCRIPTION OF THE INVENTION

The following description describes various features and functions of the disclosed system and apparatus. The illustrative aspects described herein are not meant to be limiting. It may be readily understood that certain aspects of the disclosed system and apparatus can be arranged and combined in a wide variety of different configurations, all of which are contemplated herein.

The following description of preferred embodiments of the invention is not intended to limit the invention to these preferred embodiments, but rather to enable any person skilled in the art to make and use this invention.

These and other features and advantages of the present invention may be incorporated into certain embodiments of the invention and will become more fully apparent from the following description as set forth hereinafter.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention are provided for illustration purpose only and not for the purpose of limiting the invention.

It is to be understood that the singular forms “a,” “an,” and “the” include plural referents unless the context clearly dictates otherwise.

It should be emphasized that the term “comprises/comprising” when used in this specification is taken to specify the presence of stated features, integers, steps or components but does not preclude the presence or addition of one or more other features, integers, steps, components or groups thereof.

Accordingly, the present invention also provides a deep neural network architecture embedded with a multi-scale special attention mechanism (MSSAM). More particularly, the present invention comprises deep neural network architecture embedded with a multi-scale special attention mechanism (MSSAM) for image classification.

Further, the present invention provides a method for image classification by incorporating a deep neural network embedded with multiscale spatial attention mechanism (MSSAM) that enhances the model's attention selectively by focusing on significant regions within the input feature map. The method according to the present invention comprises various stages including but not limited to:
1. Stage I—Data preparation stage—In this stage, data is collected from a large and diverse dataset of images relevant to the specific classification task, the data is split and divided into three sets: training set, validation set and test sets, the data is processed by resizing the images to the required dimensions and augmented to increase the diversity of the training dataset.
2. Stage II—Model training stage—During the model training stage, the first set i.e training set is utilized and a model architecture is established using the deep learning neural network; comprising of Parallel convolutional layers by Concatenation of Feature Maps; Custom Spatial Attention; Batch Normalization; Integration of MSSAM; Max Pooling; Additional Convolutional Layers; Fully Connected Layers; Dropout Regularization and Final Classification Layer. An appropriate loss function is selected by the model architecture for the classification task. An optimizer and an initial learning rate is chosen. The model is trained on the training dataset, monitoring validation performance and experiments are performed with hyperparameters including but not limited to batch size, dropout rates, the number of filters in convolutional layers, and the size of fully connected layers to optimize model performance.
3. Stage III—Evaluation and Testing stage:—During the Evaluation and Testing stage, the model's performance is evaluated on the second set i.e. validation set using metrics including but not limited to accuracy, precision, recall, and F1-score wherein at the final stage, model's performance is evaluated on a third set i.e. test set to obtain an unbiased estimate of its performance.
4. Stage IV—Iterative optimization stage:—During the Iterative optimization stage, the optimization process is often iterative, continuously monitored for overfitting and underfitting, adjusting regularization techniques as necessary and fine-tuning the model on specific subsets of the data.

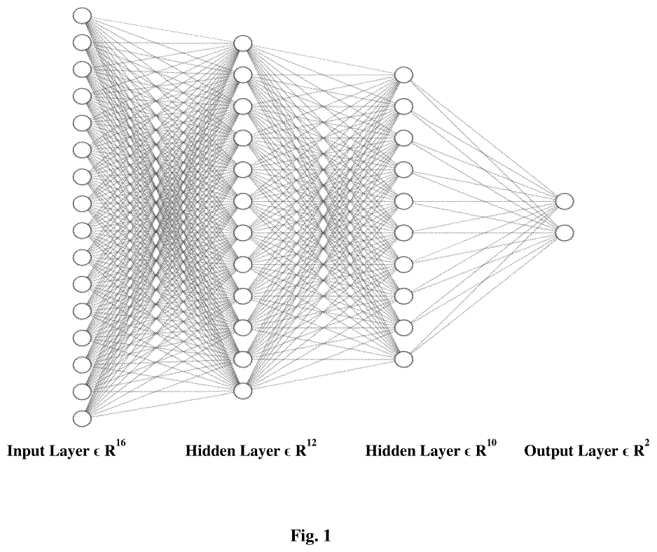

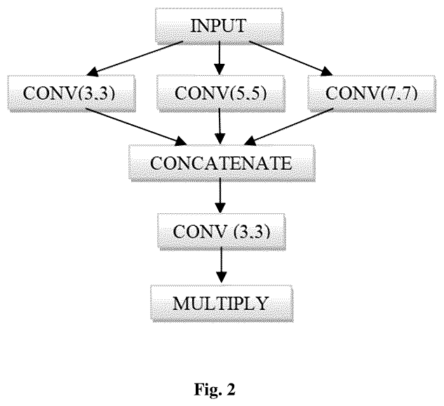

FIG. 1 provides a schematic representation of a neural network. It typically consists of multiple layers, including an input, and an output and multiple hidden layers, with arrows or connections between them. FIG. 2 illustrates a Multi-Scale Spatial Attention Mechanism (MSSAM). MSSAM plays a vital role in enhancing the model's feature extraction capabilities by selectively focusing on significant regions within input feature maps. In a preferred embodiment of the present invention, this model is run on NVIDIA GPU V100 on a HP OMEN 15 Machine.

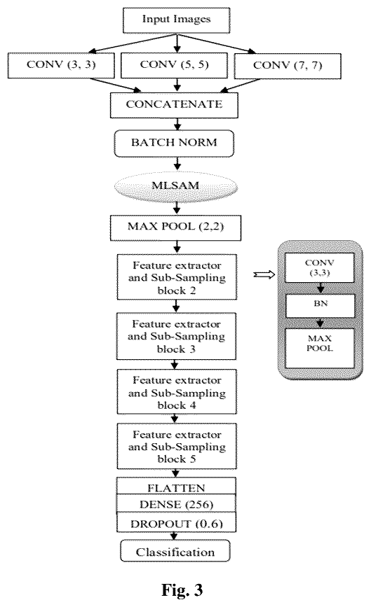

FIG. 3 illustrates a Multi-Scale Spatial Attention Mechanism (MSSAM) embedded between Batch Normalization and Max Pooling layers in the deep neural network architecture according to the present invention. The novel architecture of the present invention effectively extracts features from input images and make accurate predictions during the image classification. The characteristic feature of the present architecture comprises:
1. Deep Neural network: FIG. 1 illustrates a schematic representation of a neural network. It typically consists of multiple layers, including an input, and an output and multiple hidden layers, with arrows representing connections between them. This figure serves as a visual representation of the fundamental architecture of a neural network. Particularly, the deep neural network comprises parallel convolutional layers. The initial layers consist of three parallel convolutional branches, each employing convolutional layers with different kernel sizes (3×3, 5×5, and 7×7) to generate feature maps, which are then concatenated. These branches capture information at various spatial scales in parallel, which is essential for recognizing objects and patterns at different levels of detail within images.
2. MSSAM Embedded in Deep Neural network: FIG. 2 illustrates the Multi-Scale Spatial Attention Mechanism (MSSAM), a critical component of the proposed methodology. MSSAM plays a vital role in enhancing the model's feature extraction capabilities by selectively focusing on significant regions within input feature maps. The Multi-Scale Spatial Attention Mechanism (MSSAM) is introduced into the deep neural network architecture between Batch Normalization and Max Pooling layers and highlights important spatial regions before sub-sampling. This can help retain crucial information while reducing spatial dimensions and computational complexity. MSSAM enhances feature extraction by directing the model's attention selectively toward significant regions within the input feature map. FIG. 3 provides an overview of the architecture of the T-Fusion Net, a deep neural network designed for image classification task. It consists of parallel branches that perform convolution with varying kernel sizes (3×3, 5×5, and 7×7). These branches generate feature maps, which are concatenated to capture multi-scale information. Subsequently, a convolutional layer with a 3×3 kernel size and sigmoid activation creates a spatial attention map. This map highlights the importance of different spatial locations within the input feature map. The spatial attention map is then combined with the original feature map through element-wise multiplication, emphasizing informative regions while suppressing less relevant ones.

Architecture of the network according to the present invention: The deep neural network architecture of the present invention has been optimized for image classification tasks. It is designed to effectively extract features from input images and make accurate predictions.

The network architecture of the present invention has been designed for image classification tasks. The architecture of T-Fusion Net gradually increases the receptive field through additional convolutional layers with varying filters which allows the model to learn more abstract and complex patterns and relationships within the input image data, contributing to improved performance. The image classification is carried out in different stages.

### Stage I: The Data Preparation Stage

IA) Data Collection: Gathering a large and diverse dataset of images relevant to the specific classification task, such as Covid vs. Non-Covid images in medical diagnosis. The collected data is subjected to data splitting. The data is divided into training, validation, and test sets (e.g., 80-10-10).
IB) Data Preprocessing: Resizing the images to the required dimensions (e.g., 224×224×3), wherein 224×224 represents the width and height of the image, and 3 denotes the RGB color channels; normalizing pixel values; and splitting the dataset into training, validation, and test sets. Hence, in the initial layers, parallel convolutional layers, and subsequent layers are carefully structured to capture diverse features at multiple scales, contributing to the overall effectiveness of the network.
IC) Data Augmentation: Applying data augmentation techniques (e.g., random rotations, flips, and brightness adjustments) to increase the diversity of the training dataset and improving model generalization.

### Stage II: Model Training:

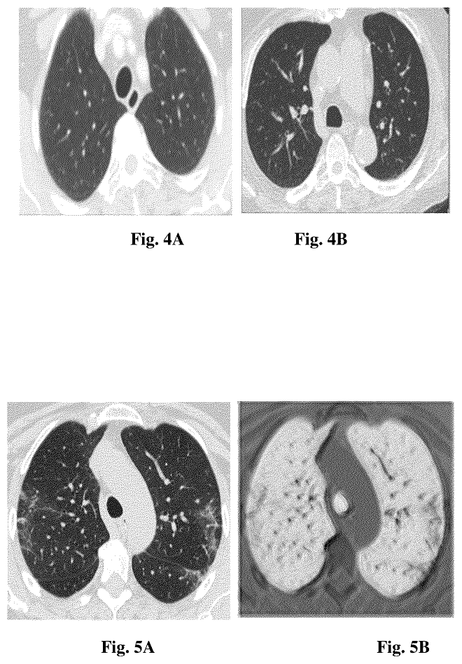

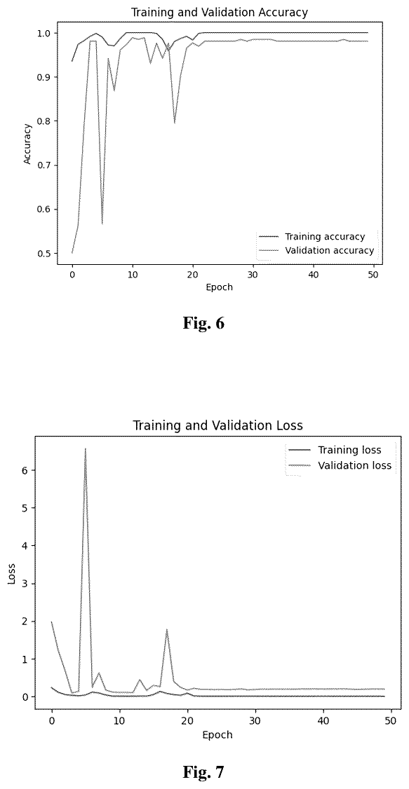

Comprises Model Architecture, Loss function; Optimizer; Training process and Hyperparameter tunings.
IIA) Model Architecture: For implementing the network architecture, such as shown in FIG. 3, various elements and protocols are included: the network; Parallel convolutional layers; Concatenation of Feature Maps; Custom Spatial Attention; Batch Normalization; Integration of MSSAM; Max Pooling; Additional Convolutional Layers; Fully Connected Layers; Dropout Regularization and Final Classification Layer.
IIA)(i) A deep neural network architecture optimized for image classification tasks is provided as shown in FIG. 1. It is designed to effectively extract features from input images and make accurate predictions.
IIA)(ii) Parallel Convolutional Layers are the initial layers consisting of three parallel convolutional branches as shown in FIG. 2, each employing convolutional layers with different kernel sizes (e.g: 3×3, 5×5, and 7×7). These branches capture information at various spatial scales in parallel, which is essential for recognizing objects and patterns at different levels of detail within images.
IIA)(iii) Concatenation of Feature Maps are maps generated by the parallel convolutional branches which are concatenated along the channel axis. This enables the model to capture diverse features from multiple scales simultaneously, enriching the feature representation and that are rich in multi-scale information.
IIA)(iv) Custom Spatial Attention selectively enhances certain spatial regions in the feature maps. As illustrated in FIG. 5A and FIG. 5B, the output received from the spatial attention block comprises proper visual representation. The output images of the module are soft segments. The Soft segmentation is a process of assigning each pixel in an image a probability distribution over multiple classes instead of a hard assignment to a single class and allows for more nuanced and probabilistic assignments, reflecting the uncertainty or partial membership of pixels to different classes.
IIA)(v) Batch Normalization is applied to the concatenated feature maps and this technique normalizes activations during training, contributing to improved model convergence and faster training. Batch normalization keeps the mean and standard deviation zero and one centered, respectively.
IIA)(vi) Integration of MSSAM in the architecture enhanced the feature extraction by directing the model's attention selectively toward significant regions within the input feature map. It consists of parallel branches that perform convolution with varying kernel sizes (eg: 3×3, 5×5, and 7×7). These branches generate feature maps, which are concatenated to capture multi-scale information. Subsequently, a convolutional layer with a 3×3 kernel size and sigmoid activation creates a spatial attention map. This map highlights the importance of different spatial locations within the input feature map. The spatial attention map is then combined with the original feature map through element-wise multiplication, emphasizing informative regions while suppressing less relevant ones.
IIA)(vii) Max Pooling layers are applied after convolutional blocks to down-sample the feature maps to reduce spatial dimensions and capture important features by decreasing computational complexity.
IIA)(viii) Additional Convolutional Layers are sequentially applied and these layers have varying numbers of filters (eg: 64, 128, 256, and 256) and use a 3×3 kernel. The sequential convolutional layers progressively increase the receptive field, enabling the model to learn more abstract and complex patterns and relationships within the input image data.
IIA)(ix) Fully Connected Layers comprise 256 units and a Rectified Linear Unit (ReLU) activation function which performs non-linear transformations to learn class-specific representations. The final feature maps are flattened into a 1-dimensional vector, which serves as input for subsequent fully connected layers.
IIA)(x) Dropout Regularization is applied with a rate of 60% to the fully connected layer to mitigate overfitting. Dropout randomly deactivates a fraction of neurons during training, helping the model generalize better to unseen data. Dense layers and dropouts are used for classification.
IIA)(xi) Final Classification Layer: The model concludes with a final classification layer consisting of two nodes with a Softmax activation function. These nodes represented the probabilities of the input image belonging to each of the two types of classes, for instance, Covid or Non-Covid. The class with the higher probability is selected as the predicted class.
IIB) Loss Function: An appropriate loss function is selected by the model architecture for the classification task, such as categorical cross-entropy for multi-class classification.
IIC) Optimizer: An optimizer (e.g., Adam, RMSprop) and an initial learning rate is chosen, e.g. a learning rate of 0.0001. The user may use learning rate schedules or techniques like early stopping to optimize learning as per protocol requirements.
IID) Training Process: The model is trained on the training dataset, monitoring validation performance as shown in FIG. 6 and FIG. 7. Techniques like gradient clipping and weight regularization are utilized to prevent overfitting.
IID)(i) FIG. 6 illustrates a graphical representation of the variation in training and validation accuracies with respect to the number of training epochs for the T-Fusion Net.
IID)(ii) X-axis (Epochs): The x-axis represents the number of training epochs. An epoch is one complete pass through the entire training dataset. As training progresses, the model updates its weights and learns to make better predictions.
IID)(iii) Y-axis (Accuracy): The y-axis represents the accuracy of the model's predictions. Accuracy measures how many of the model's predictions are correct, typically represented as a percentage.
IID)(iv) Training Accuracy Curve: The curve labeled “Training Accuracy” shows how the accuracy of the T-Fusion Net on the training data changes as the number of training epochs increases. This curve illustrates how well the model is learning from the training data. In general, the training accuracy tends to increase as the model becomes more knowledgeable about the data.
IID)(v) Validation Accuracy Curve: The curve labeled “Validation Accuracy” shows how the accuracy of the T-Fusion Net on a separate validation dataset changes with each epoch. The validation dataset is not used for training but serves as an independent measure of the model's generalization performance. An increase in validation accuracy indicates that the model is not only memorizing the training data but also learning to make accurate predictions on new, unseen data.
IID)(vi) FIG. 7 illustrates the variation in training and validation loss values with respect to the number of training epochs for the T-Fusion Net with the Multi-Scale Spatial Attention Mechanism (MSSAM). This figure provides insights into how the loss, which represents the error in the model's predictions, changes during the training process.
IID)(vii) X-axis (Epochs): The x-axis represents the number of training epochs, wherein each epoch corresponds to one pass through the entire training dataset.
IID)(viii) Y-axis (Loss): The y-axis represents the loss values. Loss measures the error or discrepancy between the model's predictions and the actual ground truth. It quantifies how far off the model's predictions are from the true values.
IID)(ix) Training Loss Curve: The curve labeled “Training Loss” shows how the training loss changes as the number of training epochs increases. It illustrates how effectively the model is minimizing errors during training. Lower training loss indicates that the model is fitting the training data better.
IID)(x) Validation Loss Curve: The curve labeled “Validation Loss” shows how the validation loss changes with each epoch on a separate validation dataset. Validation loss is an indicator of how well the model generalizes to new, unseen data. A lower validation loss suggests better generalization.
IIE) Hyperparameter Tuning: The model is experimented with hyperparameters such as batch size, dropout rates, the number of filters in convolutional layers, and the size of fully connected layers to optimize model performance.

### Stage III: Evaluation and Testing:

IIIA) Model Evaluation: The model's performance is evaluated on the validation set using metrics like accuracy, precision, recall, top-1error and F1-score. Adjusted hyperparameters as per need.
IIIB) Test Set Evaluation: Finally, assessed the model's generalization on a separate test set to obtain an unbiased estimate of its performance.

### Stage IV: Iterative Optimization:

IVA) Iterative Process: The optimization process is often iterative. Revisiting data preprocessing, model architecture, and hyperparameters is required multiple times to achieve the best results.
IVB) Regularization: Continued to monitor for overfitting and underfitting, adjusting regularization techniques (e.g., dropout rates) as necessary.
IVC) Fine-Tuning: Fine-tuning the model on specific subsets of the data or incorporating transfer learning from pre-trained models if relevant. Optimizing the results of a deep learning model is a complex and iterative process that often requires experimentation and careful consideration of data, model architecture, and hyperparameters. The specific conditions and choices will depend on the dataset and classification task at hand.

Thus, the preferred embodiments of the methodology consist of the T-Fusion Net architecture with Multi-Scale Spatial Attention which enables effective feature extraction and classification by providing importance to salient regions of input images across multiple scales. This approach enhances the model's performance in image classification tasks, with a particular focus on but not limited to Covid-19 detection, and showcases innovation in deep learning for computer vision.

### EXAMPLES

The present invention may be clearly understood from the following exemplary embodiments. The examples hereinbelow are the mere embodiments and should not be construed to limit the scope of the present invention.

### Example 1: The Model Architecture

### Input Layer:

Shape: (224, 224, 3)

### Convolutional Layer 1:

Filters: 16
Kernel Size: (3, 3)
Padding: ‘same’
Activation: ReLU

### Convolutional Layer 2:

Filters: 16
Kernel Size: (5, 5)
Padding: ‘same’
Activation: ReLU

### Convolutional Layer 3:

Filters: 16
Kernel Size: (7, 7)
Padding: ‘same’
Activation: ReLU

### Concatenate Layer:

Concatenates the outputs of conv_1, conv_11, and conv_111 along the channel axis.

### Batch Normalization Layer:

Normalizes the concatenated feature maps.

### Custom Spatial Attention Layer:

Applies our custom spatial attention mechanism to the output of bn1.

### MaxPooling2D Layer:

Pooling Size: (2, 2)

### Convolutional Layer 4:

Filters: 64
Kernel Size: (3, 3)
Padding: ‘same’
Activation: ReLU

### Batch Normalization Layer:

Normalizes the output of conv_3.

### MaxPooling2D Layer:

Pooling Size: (2, 2)

### Convolutional Layer 5:

Filters: 128
Kernel Size: (3, 3)
Padding: ‘same’
Activation: ReLU

### Batch Normalization Layer:

Normalizes the output of conv_5.

### MaxPooling2D Layer:

Pooling Size: (2, 2)

### Convolutional Layer 6:

Filters: 256
Kernel Size: (3, 3)
Padding: ‘same’
Activation: ReLU

### Batch Normalization Layer:

Normalizes the output of conv_7.

### MaxPooling2D Layer:

Pooling Size: (2, 2)

### Convolutional Layer 7:

Filters: 256
Kernel Size: (3, 3)
Padding: ‘same’
Activation: ReLU

### Batch Normalization Layer:

Normalizes the output of conv_9.

### MaxPooling2D Layer:

Pooling Size: (2, 2)

### Flatten Layer:

Flattens the output of the max-pool layer.

### Fully Connected Layer:

Units: 256
Activation: ReLU

### Dropout Layer:

Dropout Rate: 0.6

### Output Layer:

Units: 2
Activation: Softmax

### Example 2: Covid-19 Detection

As shown in FIG. 4A and FIG. 4B, image acquired from SARS-COV-2 CT scan dataset, that is, (FIG. 4A) Covid-19 and FIG. 4B for Non Covid-19, are used as input data for the image classification task specifically for distinguishing between Covid-19 cases and Non Covid-19 cases.

Image FIG. 4A represents a CT scan or radiological image of a patient's chest or lung area with Covid-19 which displays characteristic patterns, opacities, or abnormalities that are indicative of Covid-19 infection. These patterns are used as features by the neural network embedded with MSSAM. In contrast, Image FIG. 4B represents a CT scan or radiological image of a patient's chest or lung area without Covid-19. It serves as a sample of non-Covid-19 cases and may appear normal or show patterns associated with other respiratory conditions or diseases.

FIG. 5A and FIG. 5B provide a visual comparison between the original input image and the intermediate feature representation obtained after passing the input image through the proposed Multi-Scale Spatial Attention Mechanism (MSSAM) module in the neural network of the present invention (also referred hereinafter as T-Fusion Net). The figure demonstrates how MSSAM impacts the feature representation of the input image.

As shown in Image (FIG. 5A), the image represents the raw data, such as a chest X-ray or CT scan image, before any processing or feature extraction whereas Image (FIG. 5B) represents intermediate feature representation of the input image after it has passed through the MSSAM module in the T-Fusion Net. This representation is a set of feature maps that highlight significant regions and patterns within the input image.

The side-by-side comparison of images illustrates how MSSAM, a critical component of the T-Fusion Net, transforms the input image into a more abstract and informative representation. MSSAM selectively enhances regions of interest within the image, making it easier for the subsequent layers of the neural network to extract meaningful features for classification.

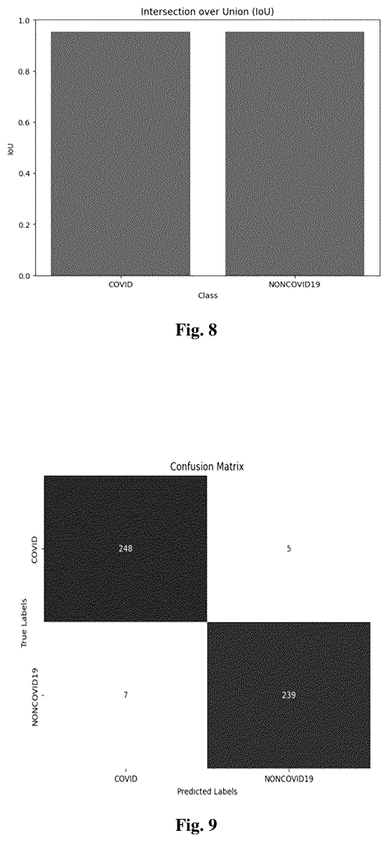

FIG. 8 displays IoU (Intersection over Union) curves for both the Covid-19 and Non Covid-19 classes. The IoU is a critical metric in image segmentation and object detection tasks and provides insights into how well the model accurately delineates objects or regions of interest within images.

FIG. 9 presents a confusion matrix for Covid-19 detection using the proposed T-Fusion Net with the Multi-Scale Spatial Attention Mechanism (MSSAM). A confusion matrix is a valuable tool for assessing the performance of a classification model, particularly in binary classification tasks like Covid-19 detection.

### Example 3: Classification Performance of the Proposed Method as to the State-of-the-Art Models for the CXR Dataset

TABLE 1

| Methods Used | Accuracy (%) |
|---|---|
| VGG-16 (Pretrained on ImageNet) | 94.62 |
| AlexNet (Pretrained on ImageNet) | 93.71 |
| VGG-19 (Pretrained on ImageNet) | 93.56 |
| DenseNet201 based deep TL | 96.25 |
| T-Fusion Net (baseline, no MSSAM) | 96.59 |
| T-Fusion Net (with MSSAM) | 97.59 |

The table (Table 1) illustrates the results of various methods used for image classification, along with their respective accuracy percentages. Here's an explanation of each method and its corresponding accuracy:

In a prior art, VGG-16 (Pretrained on ImageNet): This method employs the VGG-16 architecture, a well-known Convolutional Neural Network (CNN), which was pretrained on the ImageNet dataset. It achieved an accuracy of 94.62%. VGG-16 is a powerful CNN architecture with 16 weight layers, known for its effectiveness in image classification tasks. In another prior art, AlexNet (Pretrained on ImageNet): Similar to VGG-16, this method uses the AlexNet architecture pretrained on the ImageNet dataset. It achieved an accuracy of 93.71%. AlexNet was one of the pioneering CNN architectures and played a crucial role in the advancement of deep learning for computer vision.

In yet another prior art, VGG-19 (Pretrained on ImageNet): This method employs the VGG-19 architecture, another variant of the VGG architecture, pretrained on ImageNet. It achieved an accuracy of 93.56%. VGG-19 is known for its deeper architecture with 19 weight layers.

In yet another prior art, DenseNet201 based deep TL: This method utilizes the DenseNet201 architecture for deep transfer learning. It achieved the highest accuracy among the methods listed, with an accuracy of 96.25%. DenseNet201 is a state-of-the-art CNN architecture known for its densely connected layers.

However, in comparison with the present invention, two different T-Fusion Net architecture were utilized. First, T-Fusion Net (Baseline, no MSSAM) and second T-Fusion Net (with MSSAM).

In the first architecture, T-Fusion Net (Baseline, no MSSAM) was utilized. This represented the baseline performance of the T-Fusion Net architecture without the Multi-Scale Spatial Attention Mechanism (MSSAM). It achieved an accuracy of 96.59%. This serves as a benchmark for evaluating the impact of MSSAM on classification accuracy.

In the second architecture, T-Fusion Net (with MSSAM) was utilized. This is the T-Fusion Net architecture with the inclusion of MSSAM, the Multi-Scale Spatial Attention Mechanism. It achieved an accuracy of 97.59%. MSSAM enhances the model's feature extraction capabilities by focusing on significant regions within input images.

Table 1 demonstrates the performance of various methods for image classification, ranging from pretrained models like VGG-16, AlexNet, and VGG-19 to a state-of-the-art DenseNet201-based approach. It also highlights the impact of MSSAM on the T-Fusion Net's performance achieving the highest accuracy among the methods listed.

### Example 4: Performance Metrics for the Proposed Model

TABLE 2

| | Proposed Model |
|---|---|
| Metrics | (T Fusion Net + MSSAM) |
| Recall | 0.9736 |
| Precision | 0.9811 |
| F1-score | 0.9773 |
| Accuracy (%) | 97.595 |
| Top-1 error (%) | 2.405 |

### These Metrics Comprises:

Recall (Sensitivity or True Positive Rate): Recall measures the proportion of true positive predictions (correctly classified positive instances) out of all actual positive instances. In this case, the proposed model achieves a recall of 0.9736, which means it correctly identifies 97.36% of the actual positive cases (e.g., Covid-19 cases) in the dataset. A high recall indicates that the model is effective at minimizing false negatives, which is crucial in applications where missing a positive case can have significant consequences.

Precision: Precision measures the proportion of true positive predictions out of all predicted positive instances. A precision of 0.9811 indicates that when the proposed model predicts a positive case, it is correct 98.11% of the time. High precision reflects a low rate of false positive predictions, which is important in applications where false alarms should be minimized.

F1-Score: The F1-score is the harmonic mean of precision and recall. It provides a balanced measure of a model's performance, considering both false positives and false negatives. An F1-score of 0.9773 signifies a high level of accuracy in classification tasks, particularly when there's a need to strike a balance between precision and recall.

Accuracy: Accuracy represents the overall correct classification rate. An accuracy of 97.595% indicates that the proposed model correctly classifies 97.595% of all instances in the dataset, irrespective of whether they are positive or negative cases. It's a widely used metric for general performance evaluation.

Top-1 Error (%): The Top-1 error rate is the percentage of misclassified instances considering only the most likely class prediction. A Top-1 error rate of 2.405% means that the model misclassifies 2.405% of the instances based on its highest confidence prediction. Lower Top-1 error rates are desirable and indicate a high level of accuracy.

The proposed model demonstrates excellent performance across various metrics. It achieves high recall, high precision, and high F1-score, indicating its effectiveness in both identifying positive cases and minimizing false positives. The high accuracy and low Top-1 error rate further emphasize the model's accuracy and reliability in image classification, particularly in the context of Covid-19 detection.

### Example 5

In an exemplary embodiment, the hardware components required for training the model comprises:

GPU (Graphics Processing Unit): The GPU is GPU Google Colab with a V100 GPU.

The V100 GPU is a powerful GPU designed by NVIDIA and belongs to the Volta architecture. It is well-suited for deep learning tasks and is commonly used for accelerating neural network training.

CPU (Central Processing Unit): The CPU is responsible for general-purpose computing tasks. During the training of deep learning models, the CPU is involved in data pre-processing, whereas training is performed on GPUs utilizing their parallel processing power.

Memory: Random Access Memory (RAM) is essential for storing and quickly accessing data during model training. Sufficient RAM is crucial, especially when dealing with large datasets and complex models. In Google Colab, the amount of available RAM (83 GB) depends on the type of virtual machine provided.

Storage: Storage is necessary for storing datasets, model checkpoints, and other files related to the training process. Google Colab provides cloud storage.

Internet Connectivity: A means for data transmission such as a stable internet connection is needed for accessing and downloading datasets, libraries, and other resources during the development and training process. For cloud-based platforms like Google Colab, a reliable internet connection is essential. For deployment, network connectivity is necessary for communication between the deployed model and the application or service using it.

Server: For deployment, a server is required with specifications suitable for serving the trained model. This could include a powerful CPU, GPU (if inference requires it), sufficient RAM, and storage.

### Advantages of the Invention

The Using Multi-Scale Spatial Attention Mechanism (MSSAM) in the T-Fusion Net offers several advantages:

Enhanced Accuracy: MSSAM improves the accuracy of image classification by allowing the model to focus on relevant image regions, reducing the risk of misclassification. The model provides 97.59% accuracy in extracting capabilities by focusing on significant regions within input image by incorporating MSSAM as shown in Table 1

Enhanced recall performance: The model provides 0.9736 recall performance metric which signifies that it correctly identifies 97.36% of actual positive cases in the data set (eg. Covid-19 positive) as shown in Table 2

Enhanced precision: The model provides 0.9811 precision metric which signifies that it correctly predicts positive cases 98.11% of the time as shown in Table 2

Enhanced F1-score: The model provides F1-score of 0.9773 which signifies high level of accuracy in classification tasks as shown in Table 2

Enhanced Feature Extraction: MSSAM allows the model to selectively focus on significant regions within images, enhancing the extraction of relevant features while ignoring irrelevant information.

Multi-Scale Information: By utilizing convolutional operations with different kernel sizes, MSSAM captures local and global patterns at various scales, providing a richer representation of image content.

Improved Discrimination: MSSAM's attention mechanism helps the model differentiate between fine details and larger structures, leading to improved discrimination between different classes in image classification tasks.

Adaptability: MSSAM is adaptable to various image sizes and can be integrated into different neural network architectures, making it versatile for a wide range of computer vision applications.

Reduced Noise: MSSAM suppresses noise and unimportant features, contributing to cleaner feature maps and potentially improving the model's robustness to noisy or cluttered input data.

Better Interpretability: The attention maps generated by MSSAM can provide insights into which parts of the image the model finds most important for classification, aiding in model interpretability and diagnostics.

Multi-Scale Feature Extraction: MSSAM captures multi-scale information from images, which is essential for recognizing objects or patterns at different levels of detail, leading to more robust and accurate classifications. The inclusion of MSSAM allows the model to extract features from images at multiple scales simultaneously. This approach enhances the model's ability to recognize patterns and objects of varying sizes within images, which is a novel way to improve image classification accuracy.

Reduced Overfitting: Batch normalization and dropout are applied to prevent overfitting, improving the model's generalization to new, unseen data.

Interpretable Attention: MSSAM provides interpretable attention maps, enabling users to understand which parts of the image are crucial for classification decisions, enhancing model transparency. MSSAM generates interpretable spatial attention maps, making it possible to understand which parts of an image are crucial for classification decisions. This transparency in the model's decision-making process is an innovative feature that aids in model diagnostics and trust.

Versatility: The methodology is adaptable to various image classification tasks and can be employed in different domains, from medical diagnosis to manufacturing quality control. Beyond traditional computer vision tasks, the methodology's potential applications extend to video analysis, and various scientific research fields, demonstrating its innovative versatility.

Efficiency: The T-Fusion Net architecture optimizes feature extraction and classification, potentially reducing computational resources required for image analysis

Potential for Automation: In fields like healthcare, manufacturing, and autonomous systems, the methodology can automate decision-making processes, reducing the need for manual intervention and saving time and resources. The methodology has the potential to automate decision-making processes in various industries, increasing efficiency and reducing the need for manual intervention. This innovation has significant implications for industries seeking to streamline operations.

Customization: Our model can fine-tune the attention mechanisms and other components to suit specific tasks and dataset, potentially leading to improved results for certain applications.

Compact: The present invention comprises the network architecture is relatively compact, with a manageable number of parameters. This can be an advantage for faster training and lower memory requirements compared to larger models.

Flexibility: The network incorporates custom attention mechanism, which allows for experimentation and adaptation to specific tasks. This flexibility can be an advantage when addressing unique challenges.

The present invention has excellent effect in various industries comprising medical image diagnosis, quality control in manufacturing, agriculture, object recognition in robotics, security, environmental monitoring, retail, autonomous vehicles, oil and gas, and geological surveys, enhancing efficiency and accuracy. Some of the industries are discussed hereunder—

Video Analysis: The methodology can be extended to video classification, object tracking, and action recognition, making it useful in surveillance, entertainment, and sports analysis.

Healthcare: Beyond COVID-19 detection, it can be applied to various medical image analysis tasks, including tumor detection, organ segmentation, and disease classification.

Finance: The methodology can assist in fraud detection, analyzing financial market data, and automating document processing in the banking and finance sectors.

Environmental Monitoring: It can be used to analyze satellite imagery for land use classification, deforestation detection, and climate change monitoring.

Automated Driving: The methodology can contribute to object detection and scene understanding in autonomous vehicles, improving their safety and reliability.

Industrial Automation: It can be employed in quality control, defect detection, and robotic vision systems in manufacturing and production environments.

Retail and E-commerce: The methodology can enhance product recommendation systems, inventory management, and cashier-less shopping experiences.

Energy Sector: In energy production and distribution, it can be used for equipment monitoring, predictive maintenance, and fault detection.

Agriculture: It can assist in crop monitoring, disease detection, and yield prediction for precision agriculture.

Education: In the field of education, it can be applied to automated grading, personalized learning, and plagiarism detection.

Entertainment: The methodology can be used for content recommendation, facial recognition in gaming, and real-time special effects in filmmaking.

Scientific Research: It can contribute to image analysis in various scientific domains, including astronomy, biology, and geology.

Although the embodiments herein are described with various specific embodiments, it will be obvious for a person skilled in the art to practice the invention with modifications. However, all such modifications are deemed to be within the scope of the invention.

We claim:

1. A method for image classification by incorporating a deep neural network embedded with multiscale spatial attention mechanism (MSSAM) comprising:
a data preparation stage, comprising
collecting input data for image classification, pre-processing and processing by resizing the images to the required dimensions, and
dataset splitting comprising dividing the dataset into training set, validation set, and test sets.
defining CNN architecture by specifying the number and types of layers, filter sizes and activation functions,
selecting an appropriate loss function for the classification task,
choosing evaluation metrics (e.g., accuracy, precision, recall, F1-score, top1-error) to monitor the model's performance during training and validation;
choosing an optimizer, an initial learning rate and other hyperparameters, and a model training stage, comprising
training the model on the training dataset and monitoring validation performance, wherein the training includes but not limited to gradient clipping, weight and biases regularization and hyperparameter tuning by experimenting on parameters including but not limited to batch size, dropout rates, the number of filters in convolutional layers, and the size of fully connected layers to optimize model performance; and
an evaluation and testing stage for evaluating model's performance on the validation set using metrics including but not limited to accuracy, precision, recall, and F1-score, wherein in final stage, model's performance is evaluated on a separate test set to obtain an unbiased estimate of its performance.
an Iterative optimization stage, configured for overfitting and underfitting, adjusting regularization techniques and fine-tuning the model on specific subsets of the data.

2. The method for image classification by incorporating a deep neural network embedded with multiscale spatial attention mechanism (MSSAM) as claimed in claim 1, wherein the model training stage comprises implementation of
Deep neural network architecture having
at least three parallel convolutional layers with different kernel sizes to generate feature maps;
Concatenate layer for Concatenation of Feature Maps generated by the parallel convolutional branches along the channel axis to capture diverse features from multiple scales simultaneously,
Custom Spatial Attention to enhance certain spatial regions in the feature maps;
Batch Normalization layer to normalize activations during training and improved model convergence and faster training.
Wherein, MSSAM is embedded between Batch Normalization and Max Pooling layers to enhance the extraction by directing the model's attention selectively toward significant regions within the input feature map
Max Pooling layers to down-sample the feature maps to reduce spatial dimensions and capture important features by decreasing computational complexity
Additional Convolutional Layers sequentially applied using varying numbers of filters.
Fully Connected Layers comprising 256 units and a Rectified Linear Unit (ReLU) activation function to perform non-linear transformations to learn class-specific representations.
Dropout Regularization applied at a rate of 60% to the fully connected layer to mitigate overfitting for randomly deactivating a fraction of neurons during training assisting the model to generalize better to unseen data.
Final Classification Layer comprising of two nodes with a Softmax activation function

3. The method for image classification by incorporating a deep neural network embedded with multiscale spatial attention mechanism (MSSAM) as claimed in claim 1, wherein the parallel convolutional layers with different kernel sizes (eg: 3×3, 5×5, and 7×7).

4. The method for image classification by incorporating a deep neural network embedded with multiscale spatial attention mechanism (MSSAM) as claimed in claim 1, wherein model's performance is evaluated on the validation set using metrics like accuracy, precision, recall, and F1-score.

5. The method for image classification by incorporating a deep neural network embedded with multiscale spatial attention mechanism (MSSAM) as claimed in claim 1, wherein MSSAM enabled the training model to selectively focus on significant regions within images, enhancing the extraction of relevant features while ignoring irrelevant information.

6. A system for image classification system incorporating a deep neural network embedded with multiscale spatial attention mechanism (MSSAM) module, comprising:
an input module configured to receive a plurality of input images for classification;
a Graphics Processing Unit (GPU) with Volta architecture to accelerate image processing;
a Central Processing Unit for data pre-processing and data processing;
a storage unit;
a means for data transmission; and
a server;
wherein the image processing module characterized in:
a Multi-Scale Spatial Attention Mechanism (MSSAM) embedded between Batch Normalization and Max Pooling layers in the deep neural network architecture;

7. The system for image classification by incorporating a deep neural network embedded with multiscale spatial attention mechanism (MSSAM) as claimed in claim 6, wherein the deep neural network architecture comprises:
at least three parallel convolutional layers with different kernel sizes to generate feature maps;
Concatenate layer for Concatenation of Feature Maps generated by the parallel convolutional branches along the channel axis to capture diverse features from multiple scales simultaneously,
Custom Spatial Attention layer to enhance certain spatial regions in the feature maps;
Batch Normalization layer to normalize activations during training and improved model convergence and faster training.
MSSAM embedded between Batch Normalization and Max Pooling layers to enhance the extraction by directing the model's attention selectively toward significant regions within the input feature map
Max Pooling layers to down-sample the feature maps to reduce spatial dimensions and capture important features by decreasing computational complexity
Additional Convolutional Layers sequentially applied using varying numbers of filters.
Fully Connected Layers comprising 256 units and a Rectified Linear Unit (ReLU) activation function to perform non-linear transformations to learn class-specific representations.
Dropout Regularization applied at a rate of 60% to the fully connected layer to mitigate overfitting for randomly deactivating a fraction of neurons during training assisting the model to generalize better to unseen data.
Final Classification Layer comprising of two nodes with a Softmax activation function

9. The system for image classification by incorporating a deep neural network embedded with multiscale spatial attention mechanism (MSSAM) as claimed in claim 3, wherein the system is adaptable to be used in image classification tasks selected from but not limited to medical diagnosis, manufacturing quality control, agriculture, object recognition in robotics, security, environmental monitoring, retail, autonomous vehicles, oil and gas, and geological surveys, enhancing efficiency and accuracy.
